(19) United States
(12) Patent Application Publication
(10) Pub. No.: US 2017/0265148 A1
(43) Pub. Date: Sep. 14, 2017

(54) POWER CONTROL BASED ON SAR AND/OR HARQ

(71) Applicant: QUALCOMM Incorporated, San Diego, CA (US)

(72) Inventors: Srinivasan BALASUBRAMANIAN, San Diego, CA (US); Leena ZACHARIAS, San Jose, CA (US)

(21) Appl. No.: 15/240,214

(22) Filed: Aug. 18, 2016

Related U.S. Application Data
(60) Provisional application No. 62/305,805, filed on Mar. 9, 2016.

(51) Int. Cl. H04W 52/24; H04W 72/04; H04L 12/26; H04L 1/18

(52) U.S. Cl. CPC H04W 52/248; H04L 1/1822; H04W 72/0413; H04L 43/0847; H04L 43/16

(57) ABSTRACT

Certain aspects of the present disclosure provide techniques that may be used to manage transmission power at a UE, for example, based on a specific absorption rate (SAR) margin and/or hybrid automatic retransmission request (HARQ) retransmission count.

### CROSS-REFERENCE TO RELATED APPLICATION(S)

This application claims the benefit of U.S. Provisional Application Ser. No. 62/305,805, entitled, “POWER CONTROL BASED ON SAR AND/OR HARQ,” filed Mar. 9, 2016, assigned to the assignee hereof and hereby expressly incorporated by reference herein.

### BACKGROUND

I. Field of the Disclosure

Certain aspects of the present disclosure generally relate to wireless communications, and more specifically to power control techniques for uplink transmissions based on a specific absorption rate (SAR) and/or packet retransmission count.

II. Description of Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

In wireless communication systems employing legacy LTE, an eNodeB may receive data from a plurality of UEs over a shared uplink channel called the Physical Uplink Shared Channel (PUSCH). In addition, control information associated with the PUSCH may be transmitted to the eNodeB by the UE via a Physical Uplink Control Channel (PUCCH) and/or an Enhanced PUCCH (ePUCCH).

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Aspects of the present disclosure relate to uplink power control in a wireless communication system.

Certain aspects of the present disclosure provide a method for managing transmission power at a user equipment (UE). The method generally includes transmitting a packet. The method also includes adjusting transmission power to be used in one or more retransmissions of the packet based, at least in part, on a retransmission count of the packet.

Certain aspects of the present disclosure provide a method for managing transmission power at a UE. The method generally includes determining a specific absorption ratio (SAR) margin over a time period based on transmission power used for one or more previous transmissions during the time period. The method also includes adjusting transmission power to be used in transmitting one or more packets on an uplink channel based, at least in part, on the determined SAR margin. The method further includes transmitting the one or more packets based on the adjusted transmission power.

Certain aspects of the present disclosure provide an apparatus for managing transmission power at a UE. The apparatus includes means for transmitting a packet. The apparatus also includes means for adjusting transmission power to be used in one or more retransmissions of the packet based, at least in part, on a retransmission count of the packet.

Certain aspects of the present disclosure provide an apparatus for managing transmission power at a UE. The apparatus includes means for determining a SAR margin over a time period based on transmission power used for one or more previous transmissions during the time period. The apparatus also includes means for adjusting transmission power to be used in transmitting one or more packets on an uplink channel based, at least in part, on the determined SAR margin. The apparatus further includes means for transmitting the one or more packets based on the adjusted transmission power.

Certain aspects of the present disclosure provide an apparatus for wireless communications. The apparatus generally includes at least one processor, a transmitter, and a memory coupled to the at least one processor. The transmitter is configured to transmit a packet. The at least one processor is configured to adjust a transmission power to be used in one or more retransmissions of the packet based, at least in part, on a retransmission count of the packet.

Certain aspects of the present disclosure provide an apparatus for wireless communications. The apparatus generally includes at least one processor, a transmitter, and a memory coupled to the at least one processor. The at least one processor is configured to determine a SAR margin over a time period based on transmission power used for one or more previous transmissions during the time period. The at least one processor is also configured to adjust transmission power to be used in transmitting one or more packets on an uplink channel based, at least in part, on the determined SAR margin. The transmitter is configured to transmit the one or more packets based on the adjusted transmission power.

Certain aspects of the present disclosure provide a computer-readable medium having computer executable code stored thereon. The computer-readable medium generally includes code for transmitting a packet, and adjusting transmission power to be used in one or more retransmissions of the packet based, at least in part, on a retransmission count of the packet.

Certain aspects of the present disclosure provide a computer-readable medium having computer executable code stored thereon. The computer-readable medium generally includes code for determining a SAR margin over a time period based on transmission power used for one or more previous transmissions during the time period, code for adjusting transmission power to be used in transmitting one or more packets on an uplink channel based, at least in part, on the determined SAR margin, and code for transmitting the one or more packets based on the adjusted transmission power.

Numerous other aspects are provided including methods, apparatus, systems, computer program products, and processing systems. To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate certain typical aspects of this disclosure and are therefore not to be considered limiting of its scope, for the description may admit to other equally effective aspects.

FIG. 1 shows a block diagram conceptually illustrating an example of a telecommunications system, in accordance with an aspect of the present disclosure;

FIG. 2 is a diagram illustrating an example of an access network, in accordance with an aspect of the present disclosure.

FIG. 3 is a diagram illustrating an example of a DL frame structure in LTE, in accordance with an aspect of the present disclosure.

FIG. 4 is a diagram illustrating an example of an UL frame structure in LTE, in accordance with an aspect of the present disclosure.

FIG. 5 is a diagram illustrating an example of a radio protocol architecture for the user and control planes, in accordance with an aspect of the present disclosure.

FIG. 6 is a diagram illustrating an example of an evolved Node B and user equipment in an access network, in accordance with an aspect of the present disclosure.

FIGS. 7-7A illustrate example operations that may be performed by a user equipment (UE), in accordance with aspects of the present disclosure.

FIGS. 8A-8B illustrate example operations for determining an SAR margin, in accordance with aspects of the present disclosure.

FIG. 9 illustrates example operations that may be performed by a user equipment (UE), in accordance with aspects of the present disclosure.

FIG. 10. illustrates example operations for adjusting transmission power based on a priority of data carried in a packet, in accordance with aspects of the present disclosure.

### DETAILED DESCRIPTION

Certain aspects of the present disclosure relate to managing transmission power at a UE. In one embodiment, a UE may apply a hybrid automatic retransmission request (HARQ) based adjustment to one or more transmissions. For example, as described in more detail below, the UE may vary transmit power for one or more retransmissions of a packet based on a retransmission count of the packet. Alternatively, or additionally, in one embodiment, a UE may apply a specific absorption rate (SAR) based adjustment to one or more transmissions. For example, as also described in more detail below, the UE may determine an available SAR margin for a given time period, and adjust the transmission power for one or more packets based on the determined SAR margin. In one aspect, as described below, the UE may adjust the transmission power based on a priority of data carried in the one or more packets.

The techniques presented herein provide a more efficient power control scheme (compared to legacy uplink power controls) that allows the UE to conserve available transmit power for situations when the UE has high priority traffic (e.g., in its uplink buffer).

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

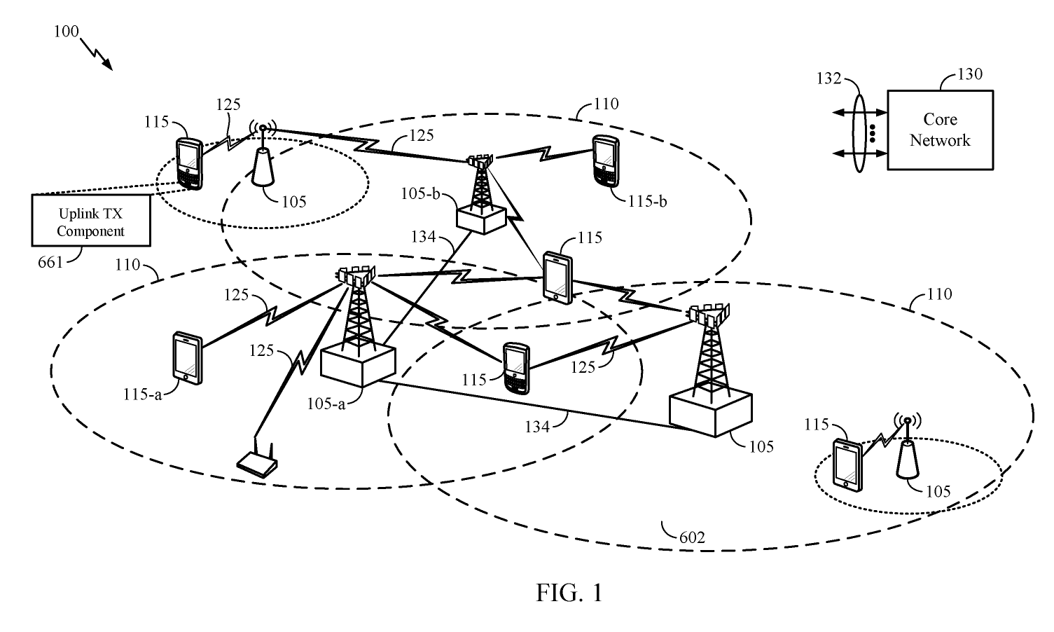

Referring first to FIG. 1, a diagram illustrates an example of a wireless communications system 100, in which aspects of the present disclosure may be performed, for example, to manage communications in the wireless communication system using the techniques for uplink power control based on SAR and/or HARQ. That is, in one aspect, a user equipment (UE) 115 may employ one or more of the techniques described herein to adjust the transmission power of one or more transmissions of a packet. In some cases, the one or more transmissions may be retransmissions of a same packet. In such cases, the UE 115 can adjust the transmission power based on a retransmission count of the packet, a type of traffic (e.g., data, channel, etc.), a latency objective for the traffic, etc. In one aspect, as described in more detail below, the UE 115 can adjust the transmission power of the one or more transmissions based on a specific absorption ratio (SAR) margin determined for one or more previous transmissions.

The wireless communications system 100 includes a plurality of access points (e.g., base stations, eNBs, or WLAN access points) 105, a number of user equipment (UEs) 115, and a core network 130. Similarly, one or more of UEs 115 may include an uplink transmitter (TX) component 661 that is configured to manage the transmission power of the UE using one or more of the techniques described herein. Some of the access points 105 may communicate with the UEs 115 under the control of a base station controller (not shown), which may be part of the core network 130 or the certain access points 105 (e.g., base stations or eNBs) in various examples. Access points 105 may communicate control information and/or user data with the core network 130 through backhaul links 132. In examples, the access points 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each communication link 125 may be a multi-carrier signal modulated according to the various radio technologies described above. Each modulated signal may be sent on a different carrier and may carry control information (e.g., reference signals, control channels, etc.), overhead information, data, etc.

In some examples, at least a portion of the wireless communications system 100 may be configured to operate on multiple hierarchical layers in which one or more of the UEs 115 and one or more of the access points 105 may be configured to support transmissions on a hierarchical layer that has a reduced latency with respect to another hierarchical layer. In some examples a hybrid UE 115-a may communicate with access point 105-a on both a first hierarchical layer that supports first layer transmissions with a first subframe type and a second hierarchical layer that supports second layer transmissions with a second subframe type. For example, access point 105-a may transmit subframes of the second subframe type that are time division duplexed with subframes of the first subframe type.

In other examples, a second layer UE 115-b may communicate with access point 105-b on the second hierarchical layer. Thus, hybrid UE 115-a and second layer UE 115-b may belong to a second class of UEs 115 that may communicate on the second hierarchical layer, while legacy UEs 115 may belong to a first class of UEs 115 that may communicate on the first hierarchical layer. Thus, second layer UE 115-b may operate with reduced latency compared to UEs 115 that operate on the first hierarchical layer.

The access points 105 may wirelessly communicate with the UEs 115 via one or more access point antennas. Each of the access points 105 sites may provide communication coverage for a respective coverage area 110. In some examples, access points 105 may be referred to as a base transceiver station, a radio base station, a radio transceiver, a basic service set (BSS), an extended service set (ESS), a NodeB, eNodeB, Home NodeB, a Home eNodeB, or some other suitable terminology. The coverage area 110 for a base station may be divided into sectors making up a portion of the coverage area (not shown). The wireless communications system 100 may include access points 105 of different types (e.g., macro, micro, and/or pico base stations). The access points 105 may also utilize different radio technologies, such as cellular and/or WLAN radio access technologies. The access points 105 may be associated with the same or different access networks or operator deployments. The coverage areas of different access points 105, including the coverage areas of the same or different types of access points 105, utilizing the same or different radio technologies, and/or belonging to the same or different access networks, may overlap.

In LTE/LTE-A network communication systems, the terms evolved Node B (eNodeB or eNB) may be generally used to describe the access points 105. The wireless communications system 100 may be a Heterogeneous LTE/LTE-A/ULL LTE network in which different types of access points provide coverage for various geographical regions. For example, each access point 105 may provide communication coverage for a macro cell, a pico cell, a femto cell, and/or other types of cell. Small cells such as pico cells, femto cells, and/or other types of cells may include low power nodes or LPNs. A macro cell generally covers a relatively large geographic area (e.g., several kilometers in radius) and may allow unrestricted access by UEs 115 with service subscriptions with the network provider. A small cell would generally cover a relatively smaller geographic area and may allow unrestricted access by UEs 115 with service subscriptions with the network provider, for example, and in addition to unrestricted access, may also provide restricted access by UEs 115 having an association with the small cell (e.g., UEs in a closed subscriber group (CSG), UEs for users in the home, and the like). An eNB for a macro cell may be referred to as a macro eNB. An eNB for a small cell may be referred to as a small cell eNB. An eNB may support one or multiple (e.g., two, three, four, and the like) cells.

The core network 130 may communicate with the eNBs or other access points 105 via a backhaul 132 (e.g., S1 interface, etc.). The access points 105 may also communicate with one another, e.g., directly or indirectly via backhaul links 134 (e.g., X2 interface, etc.) and/or via backhaul links 132 (e.g., through core network 130). The wireless communications system 100 may support synchronous or asynchronous operation. For synchronous operation, the access points 105 may have similar frame timing, and transmissions from different access points 105 may be approximately aligned in time. For asynchronous operation, the access points 105 may have different frame timing, and transmissions from different access points 105 may not be aligned in time. Furthermore, transmissions in the first hierarchical layer and second hierarchical layer may or may not be synchronized among access points 105. The techniques described herein may be used for either synchronous or asynchronous operations.

An interlace structure may be used for each of the downlink and uplink for FDD in LTE. For example, Q interlaces with indices of 0 through Q−1 may be defined, where Q may be equal to 4, 6, 8, 10, or some other value. Each interlace may include subframes that are spaced apart by Q frames. In particular, interlace q may include subframes q, q+Q, q+2Q, etc., where qε{0, . . . , Q−1}.

The wireless communications system 100 may support hybrid automatic retransmission request (HARQ) for data transmission on the downlink and/or uplink. For HARQ, a transmitter (e.g., a UE) may send one or more transmissions of a packet until the packet is decoded correctly by a receiver (e.g., an eNB) or some other termination condition is encountered. For synchronous HARQ, all transmissions of the packet may be sent in subframes of a single interlace. For asynchronous HARQ, each transmission of the packet may be sent in any subframe. In some examples, an eNB 105 may acknowledge receipt of a transmission by providing ACK/NACK for the transmission through, for example, a HARQ scheme.

The UEs 115 are dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNodeBs, small cell eNodeBs, relays, and the like. A UE 115 may also be able to communicate over different access networks, such as cellular or other WWAN access networks, or WLAN access networks.

The communication links 125 shown in wireless communications system 100 may include uplink (UL) transmissions from a UE 115 to an access point 105, and/or downlink (DL) transmissions, from an access point 105 to a UE 115. The downlink transmissions may also be called forward link transmissions while the uplink transmissions may also be called reverse link transmissions. The communication links 125 may carry transmissions of each hierarchical layer which, in some examples, may be multiplexed in the communication links 125. The UEs 115 may be configured to collaboratively communicate with multiple access points 105 through, for example, Multiple Input Multiple Output (MIMO), carrier aggregation (CA), Coordinated Multi-Point (CoMP), or other schemes. MIMO techniques use multiple antennas on the access points 105 and/or multiple antennas on the UEs 115 to transmit multiple data streams. Carrier aggregation may utilize two or more component carriers on a same or different serving cell for data transmission. CoMP may include techniques for coordination of transmission and reception by a number of access points 105 to improve overall transmission quality for UEs 115 as well as increasing network and spectrum utilization.

As mentioned, in some examples access points 105 and UEs 115 may utilize carrier aggregation (CA) to transmit on multiple carriers. In some examples, access points 105 and UEs 115 may concurrently transmit in a first hierarchical layer, within a frame, one or more subframes each having a first subframe type using two or more separate carriers. Each carrier may have a bandwidth of, for example, 20 MHz, although other bandwidths may be utilized. Hybrid UE 115-a, and/or second layer UE 115-b may, in certain examples, receive and/or transmit one or more subframes in a second hierarchical layer utilizing a single carrier that has a bandwidth greater than a bandwidth of one or more of the separate carriers. For example, if four separate 20 MHz carriers are used in a carrier aggregation scheme in the first hierarchical layer, a single 80 MHz carrier may be used in the second hierarchical layer. The 80 MHz carrier may occupy a portion of the radio frequency spectrum that at least partially overlaps the radio frequency spectrum used by one or more of the four 20 MHz carriers. In some examples, scalable bandwidth for the second hierarchical layer type may be combined with other techniques to provide shorter RTTs such as described above, to provide further enhanced data rates.

Each of the different operating modes that may be employed by wireless communication system 100 may operate according to frequency division duplexing (FDD) or time division duplexing (TDD). In some examples, different hierarchical layers may operate according to different TDD or FDD modes. For example, a first hierarchical layer may operate according to FDD while a second hierarchical layer may operate according to TDD. In some examples, OFDMA communications signals may be used in the communication links 125 for LTE downlink transmissions for each hierarchical layer, while single carrier frequency division multiple access (SC-FDMA) communications signals may be used in the communication links 125 for LTE uplink transmissions in each hierarchical layer. Additional details regarding implementation of hierarchical layers in a system such as the wireless communications system 100, as well as other features and functions related to communications in such systems, are provided below with reference to the following figures.

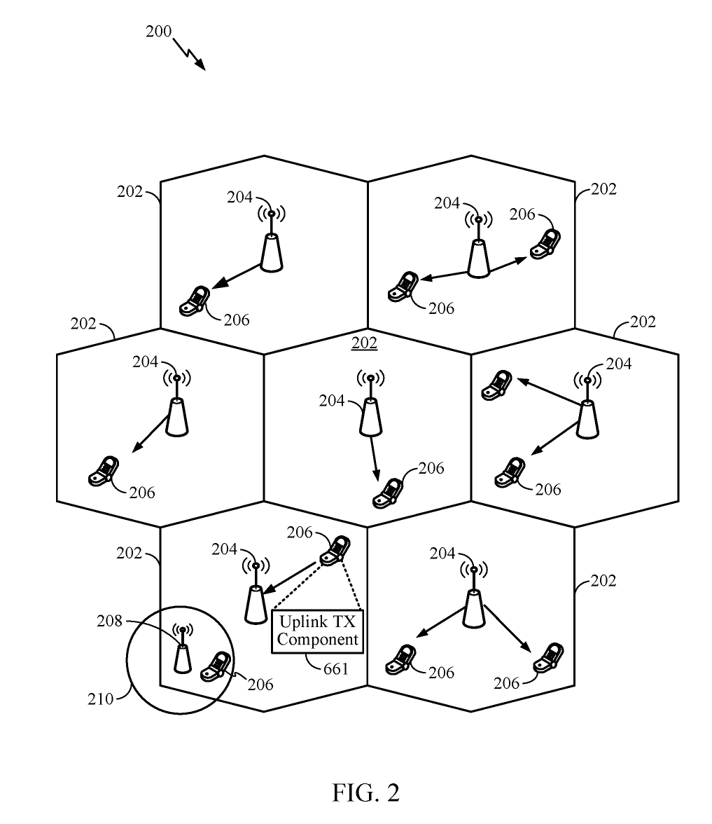

FIG. 2 is a diagram illustrating an example of an access network 200 in an LTE network architecture, in which aspects of the present disclosure may be performed, for example, to manage communications in the wireless communication system using the techniques for uplink power control based on SAR and/or HARQ.

In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the core network 130 for all the UEs 206 in the cells 202. Similarly, one or more of UEs 206 may include an uplink TX component 661 that is configured to manage the transmission power of the UE using one or more of the techniques described herein. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

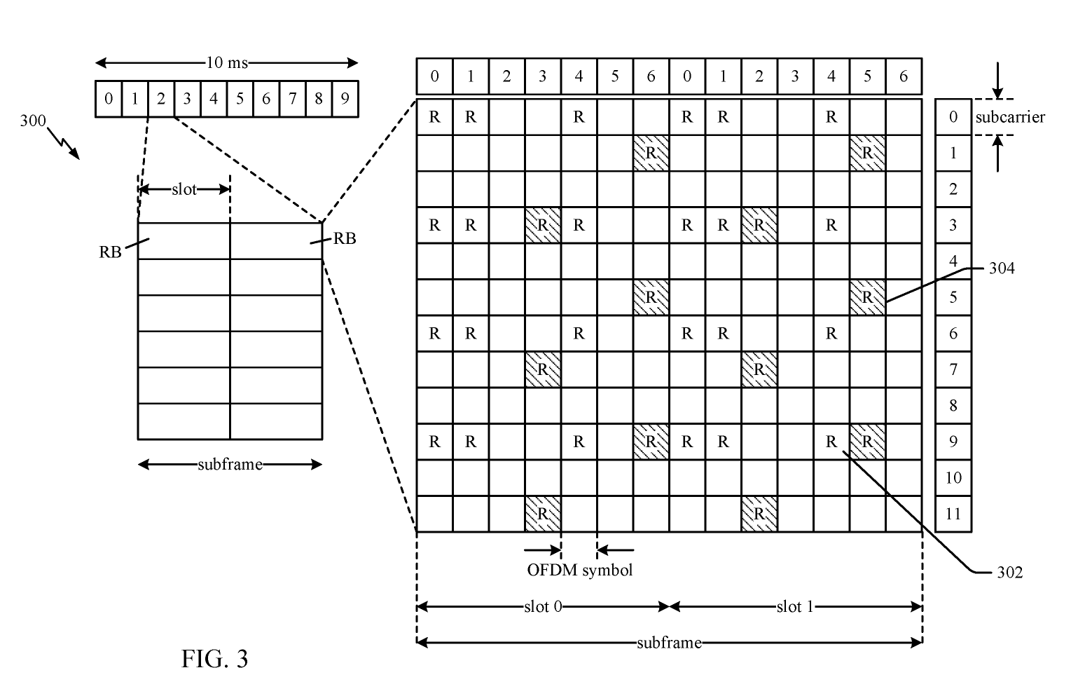

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource element block. The resource grid is divided into multiple resource elements. In LTE, a resource element block may contain 12 consecutive subcarriers in the frequency domain and, for a normal cyclic prefix in each OFDM symbol, 7 consecutive OFDM symbols in the time domain, or 84 resource elements. For an extended cyclic prefix, a resource element block may contain 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted on the resource element blocks upon which the corresponding PDSCH is mapped. The number of bits carried by each resource element depends on the modulation scheme. Thus, the more resource element blocks that a UE receives and the higher the modulation scheme, the higher the data rate for the UE.

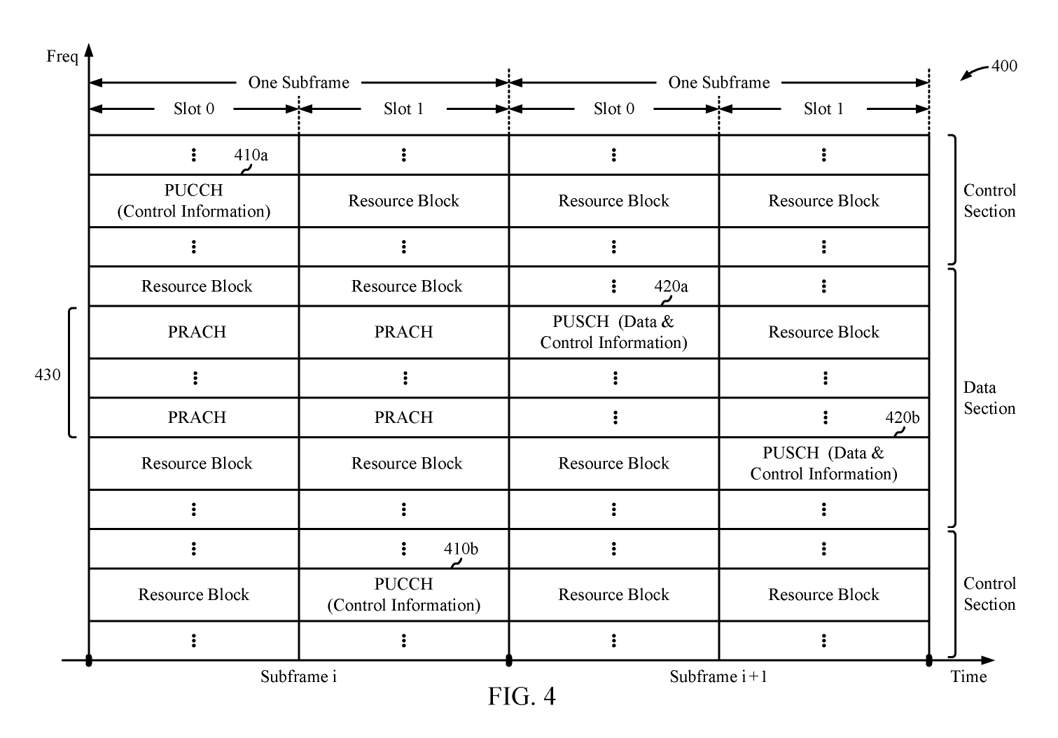

FIG. 4 is a diagram 400 illustrating an example of an UL frame structure in LTE. The available resource element blocks for the UL may be partitioned into a data section and a control section. The control section may be formed at the two edges of the system bandwidth and may have a configurable size. The resource element blocks in the control section may be assigned to UEs for transmission of control information. The data section may include all resource element blocks not included in the control section. The UL frame structure results in the data section including contiguous subcarriers, which may allow a single UE to be assigned all of the contiguous subcarriers in the data section.

A UE may be assigned resource element blocks 410a, 410b in the control section to transmit control information to an eNB. The UE may also be assigned resource element blocks 420a, 420b in the data section to transmit data to the eNB. The UE may transmit control information in a physical UL control channel (PUCCH) on the assigned resource element blocks in the control section. The UE may transmit only data or both data and control information in a physical UL shared channel (PUSCH) on the assigned resource element blocks in the data section. A UL transmission may span both slots of a subframe and may hop across frequency.

A set of resource element blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource element blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make a single PRACH attempt per frame (10 ms).

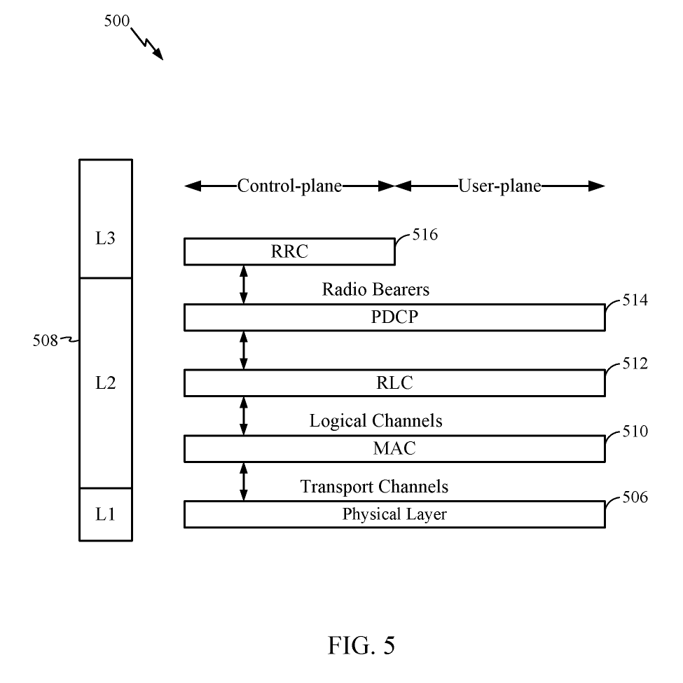

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource element blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

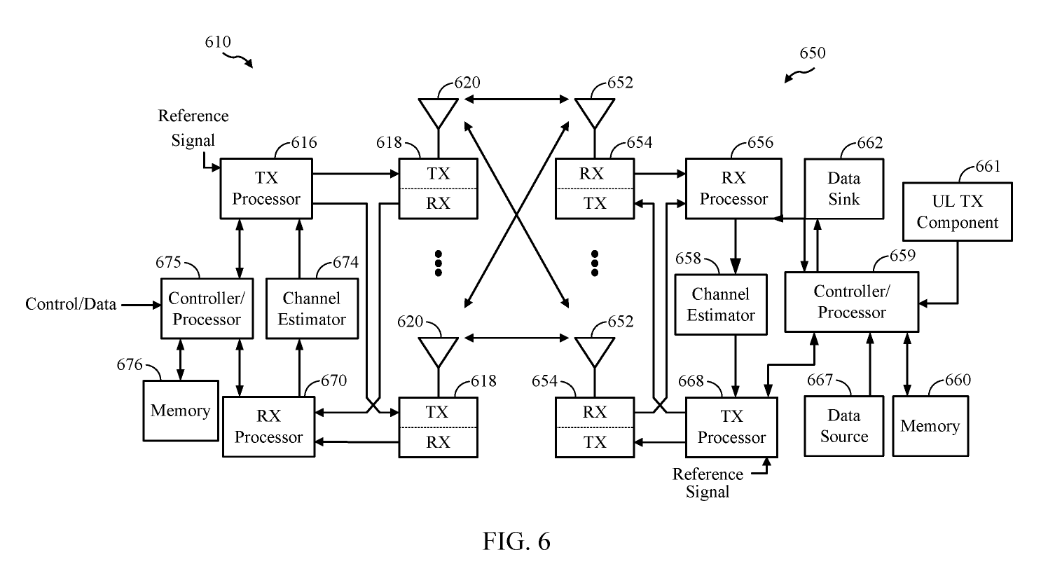

FIG. 6 is a block diagram of an eNB 610 in communication with a UE 650 in an access network, in accordance with aspects of the present disclosure. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations. In addition, UE 650 may include an uplink transmitter component 661 configured to manage transmission power at the UE (e.g., based on HARQ and/or a SAR margin).

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The controller/processor 675 may direct the operation at the eNB 610.

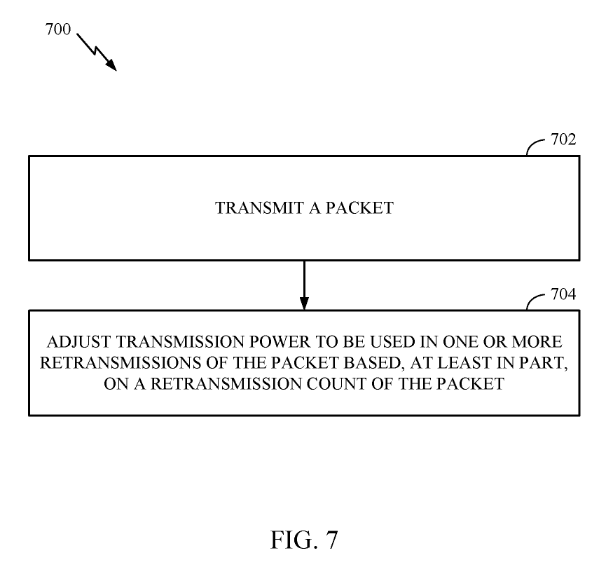

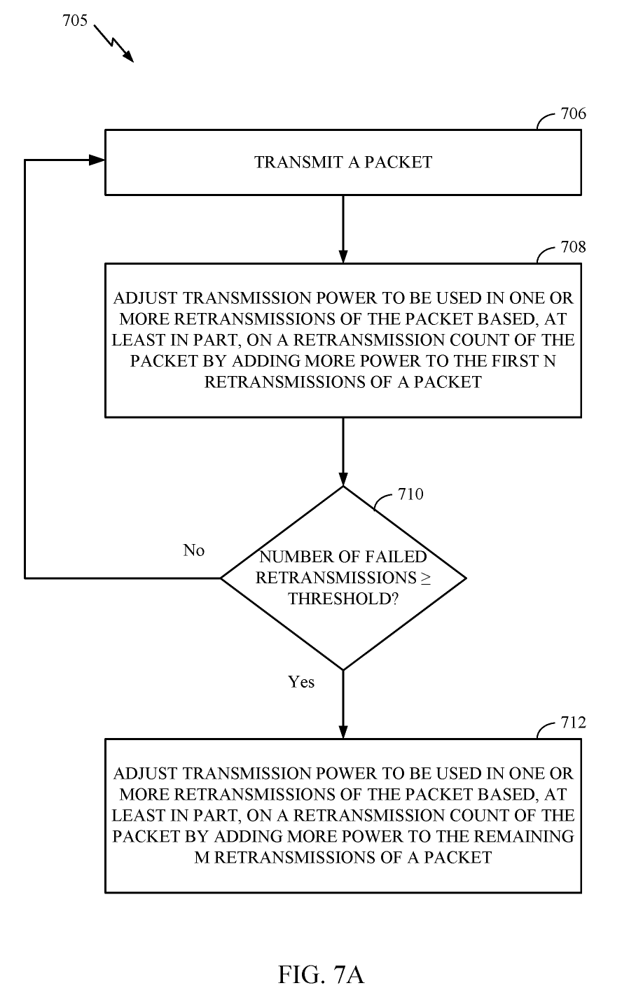

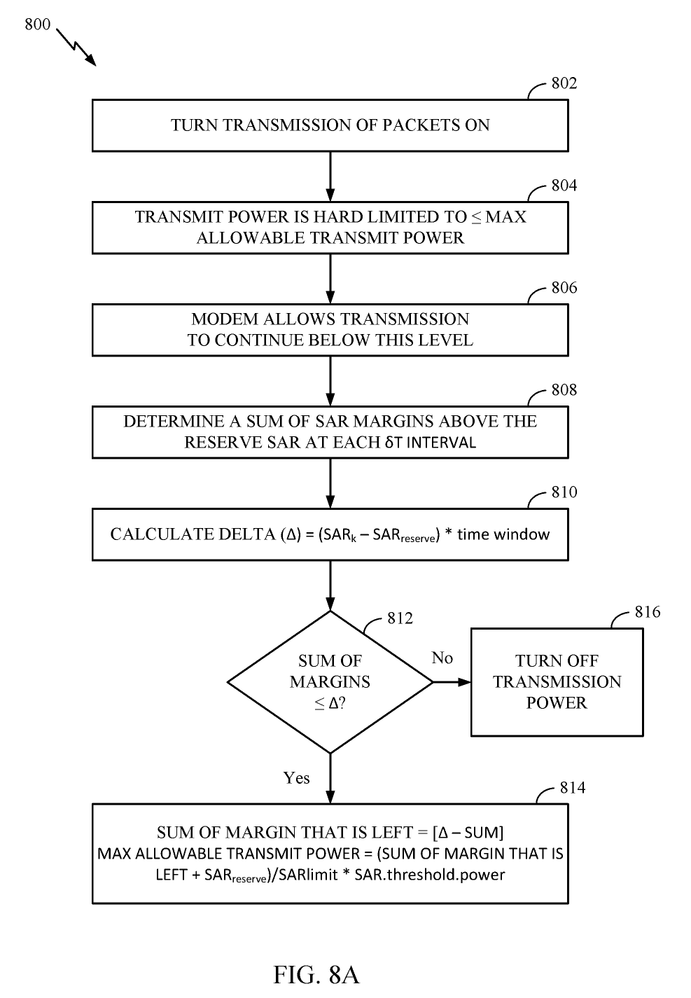

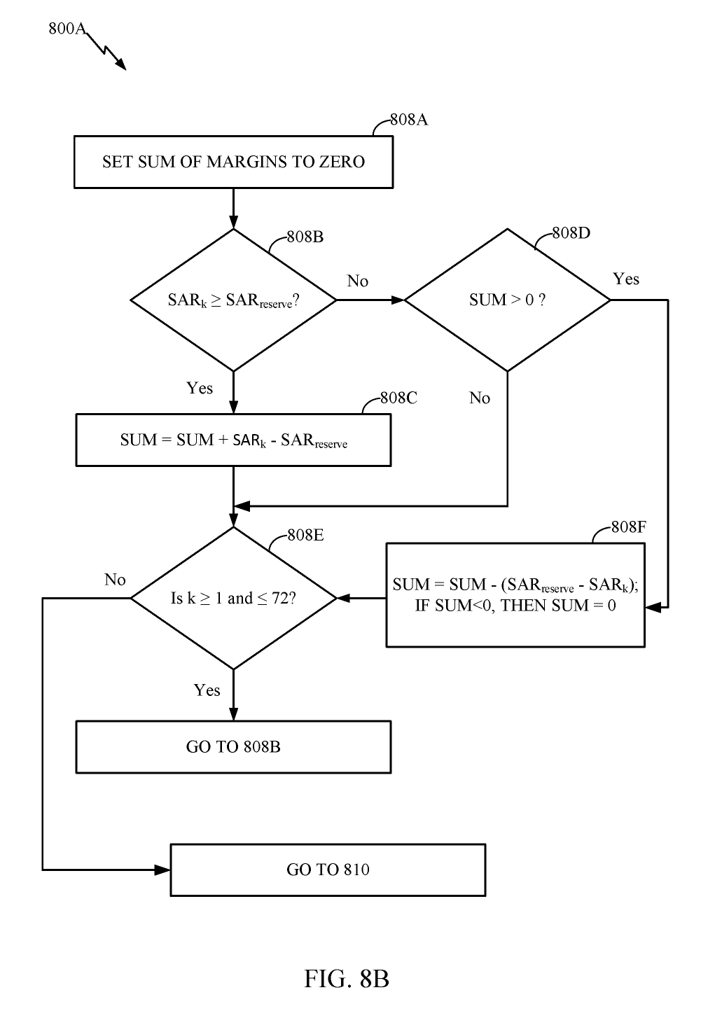

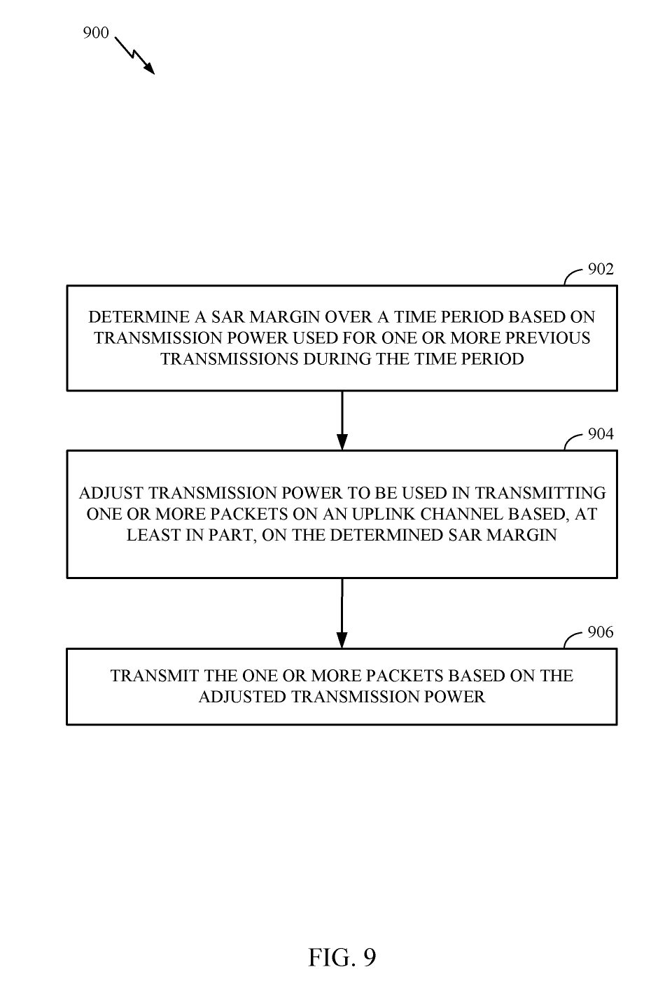

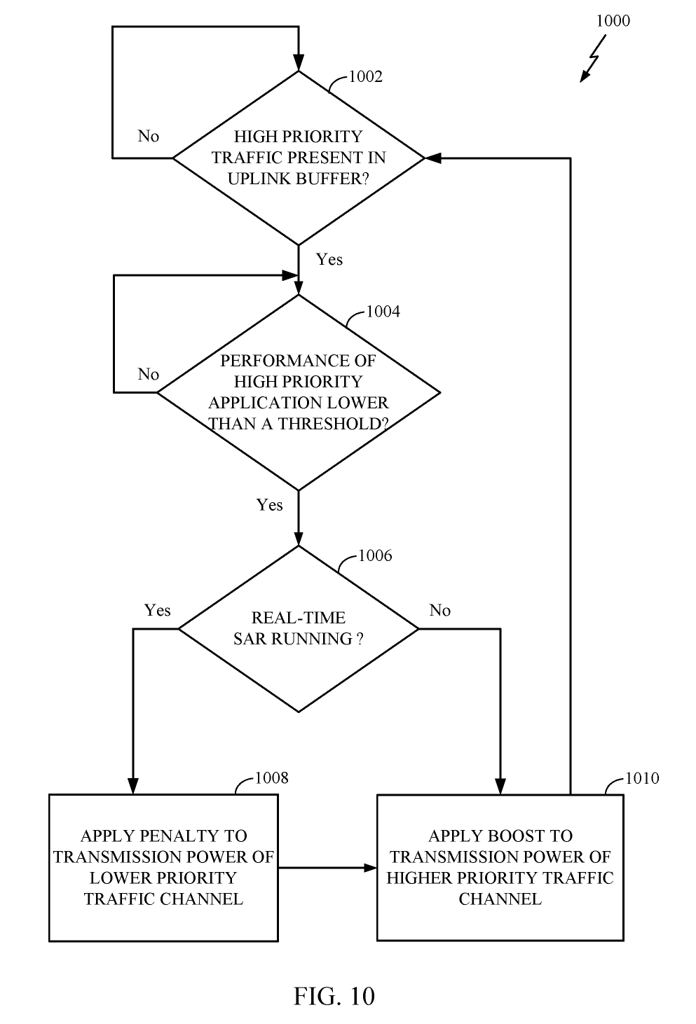

The controller/processor 659 may direct the operation at the UE 650. For example, the controller/processor 659, RX processor 656, TX processor 668, UL TX component 661 and/or other processors, components, and/or modules at the UE 650 may perform or direct operations 700 illustrated in FIG. 7, operations 705 illustrated in FIG. 7A, operations 800 illustrated in FIG. 8A, operations 800A illustrated in FIG. 8B, operations 900 illustrated in FIG. 9, operations 1000 illustrated in FIG. 10 and/or other processes or operations performed by the UE as described herein. As described in more detail below, techniques and apparatus presented herein provide improvements for UE power control. In one aspect, an improved power control technique based on HARQ (re)transmission is provided. In one aspect, an improved power control technique based on SAR margin is provided.

### Example Uplink Power Control Based on HARQ

LTE, in general, may support both open-loop and close-loop techniques for uplink power control. For PUSCH power control, both accumulative and absolute power control modes may be supported. For PUCCH power control, accumulative power control may be supported. In some cases, the UE may be configured via higher layers for the particular power control mode that is to be used. However, although various techniques exist for uplink power control, these uplink power control methods typically do not allow the UE to adjust transmit power based on HARQ retransmissions. Equation (1), for example, illustrates one reference example of a formula used to determine UL transmit power for PUSCH in LTE:

$${P}_{PUSCH , c} ( i ) = min \{ \begin{matrix}{P}_{CMAX , c} ( i ) \\ 10 {log}_{10} ( {M}_{PUSCH , c} ( i ) ) + {P}_{O\_PUSCH , c} ( j ) + {α}_{c} ( j ) \cdot {PL}_{c} + {Δ}_{TF , c} ( i ) + {f}_{c} ( i )\end{matrix} \} \qquad ( 1 )$$

where M_{PUSCH,c}(i) is the number of resource blocks in the PUSCH resource assignment, P_{O}_{_}_{PUSCH,c}(j) is the nominal open loop power set according to configuration, α_{c}(j)·PL_{c} is the path loss compensation, Δ_{TF,c}(i) is the MCS based factor, and f_{c}(i) is the closed loop power adjustment. As shown above, however, equation (1) does not provide explicit UE control for HARQ retransmission based power control.

Aspects presented herein provide techniques for managing uplink transmission power at a UE, in part, based on a HARQ retransmission count.

FIG. 7 illustrates example operations 700 that may be performed by a UE (e.g., UE 115, UE 206, etc.) to manage uplink transmission power at the UE, according to an aspect of the present disclosure. As illustrated, operations 700 begin at 702, where a UE transmits a packet. At 704, the UE adjusts transmission power to be used in one or more retransmissions of the packet based, at least in part, on a retransmission count of the packet.

FIG. 7A illustrates additional operations 705 that may be performed by a UE (e.g., UE 115, UE 206, etc.) to manage transmission power at the UE, according to an aspect of the present disclosure. As illustrated, operations 705 begin at 706, where a UE transmits a packet. At 708, the UE adjusts transmission power to be used in one or more retransmissions of the packet based, at least in part, on a retransmission count of the packet by adding more power to the first n (re)transmissions of the packet. In one aspect, the UE may determine a value of n based on a type of traffic/channel (e.g., being transmitted). At 710, the UE determines whether the number of failed retransmissions is greater than or equal to a threshold. If so, at 712, the UE may add more power (e.g., boosting the transmission power) to a remaining m retransmissions of the packet. In one aspect, the UE may determine a value of m based on a type of traffic/channel.

Power control may be used to boost particular HARQ (re)transmissions at a UE for a packet such that a goal for that traffic type is met. According to aspects, the UE may vary the uplink transmit power as a function of a HARQ retransmission count. For example, in one embodiment, the UE may adjust the transmission power by increasing the transmission power to be used for a number of retransmissions of the packet. In one reference example, the UE may add more power to the first n (re)transmissions of the packet. In some cases, the number (n) of retransmissions may be based on a type of channel being transmitted. In some cases, the number (n) of retransmissions may be based on a type of data carried in the packet. In some cases, the number (n) of retransmissions may be based on a latency specification for data carried in the packet. For example, low latency applications may have a low configured value of n, as compared to higher latency applications.

According to aspects, in one embodiment, the UE may adjust the transmission power based on detection of a threshold number of failed transmissions of the packet. For example, if the first m transmissions fail, then the UE may increase the power of the remaining retransmissions. In some cases, the threshold number may be based on at least one of a type of channel being transmitted or a type of data carried in the packet.

The techniques presented herein also provide techniques for HARQ based power adjustment in EVDO reverse link. For example, EVDO generally has sub-packets (1-4) corresponding to HARQ retransmissions. The gain of the data channel relative to the power channel may depend on a traffic to pilot (T2P) power ratio profile. There may also be two transmission modes: low latency and high capacity.

The transmit power may be determined according to a sub-packet number and whether the UE is in a low latency mode vs. high capacity mode. For example, in low latency mode, the sub-packet N power relative to the pilot is given by PktT×T2P_{n,N}=T2PLoLatPreTransitionPS if N<=LoLatT2PTransitionPS and PktTxT2P_{n,N}=T2PLoLatPostTransitionPS if N>LoLatT2PTransitionPS.

In high capacity mode, the sub-packet N power relative to the pilot is given by PktTxT2P_{n,N}=T2PHiCapPreTransitionPS if N<=HiCapT2PTransitionPS and PktTxT2P_{n,N}=T2PHiCapPostTransitionPS if N>HiCapT2PTransitionPS.

### Example Uplink Power Control Based on SAR

Alternatively, or additionally, the UE may vary uplink transmit power based on a SAR limit.

Wireless communication devices (e.g., mobile cell phones, personal data assistants, laptops, and the like) are generally subject to regulatory radio frequency (RF) safety specification. For example, devices operating near the human body are evaluated to determine the Specific Absorption Rate (SAR) their electromagnetic waves produce. SAR is the time-rate of electromagnetic energy absorption per unit of mass in a lossy media, and may be expressed as follows:

$$SAR ( r ) = \frac{σ ( r )}{ρ ( r )} {\vert E ( r ) \vert}_{rms}^{2} \qquad ( 2 )$$

where E(r) is the exogenous electric field at point r, rms stands for root mean square, while σ(r) and ρ(r) are the corresponding equivalent electrical conductivity and mass density, respectively. Generally, SAR testing evaluates the amount of energy absorbed into the body from a device with single or multiple transmitters. In some cases, a UE may have Specific Absorption Ratio (SAR) specifications that should be met on an averaged basis. In such cases, a UE may be left with too less power margin for high priority traffic, causing it to limit the transmit power in order to comply with the SAR specifications.

In some cases, the SAR specification may be an instantaneous SAR limit that the UE is not allowed to exceed at any given point in time. In other cases, the SAR specification may be a time averaged SAR limit (instead of a instantaneous limit), such that the UE can exceed the SAR limit at times as long as the time-averaged SAR is below the SAR limit. In some cases, the time-averaged SAR may be averaged across the last six minutes and in any interval (e.g., four-five second intervals).

According to certain aspects, the UE may compute a SAR margin left above a reserve SAR level in a given time window. FIG. 8, for example, illustrates example operations 800 that may be performed by a UE (e.g., UE 115, UE 206, etc.) to manage uplink transmission power at the UE, according to an aspect of the present disclosure.

As illustrated, operations 800 may begin at 802, where a UE beings turns transmissions of one or more packets on (i.e., the UE begins transmitting one or packets). At 804, the transmission power is hard limited to less than or equal to the max allowable transmit power. At 806, the UE's modem may allow the transmission of packets to continue below this level. At 808, the UE may determine the value “sum” of margin above a reserve SAR at each time interval. The reserve SAR level may ensure that the UE does not drop the connection. As described in more detail below, to determine the value “sum,” the UE may perform sub-operations 800A shown in FIG. 8B.

Once the UE computes the delta SAR margin, the UE may limit the transmit power to the maximum allowable transmit power based on the SAR margin left in the given window. For example, as shown in FIG. 8A at 812, the UE determines whether the value “sum” is less than or equal to Δ=(SARₗᵢₘᵢₜ−SARᵣₑₛₑᵣᵥₑ)*timewindow. If so, the UE determines the maximum available transmit power based on the determination at step 814. The UE then allows transmission to continue below this level. On the other hand, if at 812, the UE determines the “sum” is not less than or equal to Δ, the transmission power is turned off at step 816 (e.g., the UE may stop the transmission of packets).

FIG. 8B illustrates operations 800A that may be performed by a UE (e.g., UE 115, UE 206, etc.) to determine a sum of SAR margin (above a reserve SAR level) for a time interval, according to an aspect of the present disclosure. In one aspect, the UE may perform operations 800A every four to five seconds over a six minute time period. Of course, those of ordinary skill in the art will recognize that the UE may perform operations 800A for other periods of time. As illustrated, operations 800A may begin at 808A, where the UE sets the sum of margins to zero. At 808B, the UE determines whether the SAR at time interval k is greater than or equal to the reserve SAR level, where k={1 . . . time period}. If so, the UE computes the “sum” SAR margin at 808C using SUM=SUM+SARₖ−SARᵣₑₛₑᵣᵥₑ. If not, the UE, at 808D, determines whether the value of “sum” is greater than zero.

If the UE determines the value of “sum” is greater than zero, the UE computes the “sum” SAR margin at 808F using SUM=SUM−(SARᵣₑₛₑᵣᵥₑ−SARₖ). Once the UE computes the “sum” SAR margin (e.g., at 808C or 808F) the UE determines at 808E if it is still within the time interval. If so, the UE proceeds to 808B. If not, the UE proceeds to 810 (e.g., in FIG. 8A). In one aspect, the available SAR margin in a window gives the max allowed transmit power in the next interval. Although the UE may transmit below this level, the UE may end up using more of the SAR margin if power levels are high. As a result, the UE may have less remaining SAR margin for the remaining intervals, which could affect the UE's transmission of high priority traffic.

Aspects presented herein provide techniques for adjusting transmission power based on an SAR margin, such that the UE can ensure that enough SAR margin is available to boost transmission power of high priority traffic.

FIG. 9 illustrates example operations 900 that may be performed by a UE to manage uplink transmission power at the UE, according to an aspect of the present disclosure. As illustrated, operations 900 begin at 902, where a UE determines a SAR margin over a time period (e.g., as described in FIG. 8) based on transmission power used for one or more previous transmissions during the time period. At 904, the UE adjusts transmission power to be used in transmitting one or more packets on an uplink channel based, at least in part, on the determined SAR margin. At 906, the UE transmits the one or more packets based on the adjusted transmission power.

In one aspect, the UE may adjust the transmission power based, in part, on a priority of data carried in the one or more packets. For example, when the UE gets high priority traffic in its UL buffer, the UE may reduce the transmitted power on other packets so that less of the SAR margin is used. In some embodiments, adjusting the transmission power based on a priority of data carried in the one or more packets includes reducing transmission power used for transmitting data having a low priority, and increasing transmission power used for transmitting data having a high priority.

In one aspect, adjusting the transmission power may include pausing a data transmission upon detecting that no SAR margin exists for the time period. In one aspect, adjusting the transmission power may include adjusting the transmission power such that the UE exceeds an instantaneous SAR limit while maintaining compliance with a SAR limit over the time period.

In some aspects, the UE may adjust the transmission power independently of SAR by booting the transmission power of high priority traffic based on its current performance. For example, if the UE determines a real time SAR averaging method is not running, the UE may determine not to penalize lower priority traffic.

FIG. 10, for example, shows example operations 1000 for adjusting the transmission power based on a priority of data. As shown, at 1002, once the UE determines that high priority traffic is present in the UL buffer, the UE proceeds to 1004 where the UE determines if the high priority application performance is lower than a threshold (e.g., if the traffic is getting a certain number of retransmissions). If so, at 1006, the UE determines if a real-time SAR averaging method is running on the UE side instead of an absolute SAR method. If so, the UE applies a penalty to the transmit power of lower priority traffic channel (1008), and applies a boost to the transmit power of higher priority traffic channel (1010). If, at 1006, the UE determines that a real-time SAR is not running, then the UE applies a boost to the transmit power of higher priority traffic channel (1010).

Doing so in this manner may leave more room for higher priority traffic, e.g., in situations where the UE is on the cell edge with larger transmit powers and less SAR margin. Additionally, the techniques presented herein may result in higher power limits being computed from SAR compliance perspective for the next window.

The various operations of methods described above may be performed by any suitable means capable of performing the corresponding functions. The means may include various hardware and/or software/firmware component(s) and/or module(s), including, but not limited to a circuit, an application specific integrated circuit (ASIC), or processor. Generally, where there are operations illustrated in the Figures (e.g., FIGS. 7-10), those operations may be performed by any suitable corresponding counterpart means plus function components. For example, means for providing, means for receiving, means for transmitting/retransmitting, means for performing, means for demodulating, means for allocating, means for determining, means for participating, means for adjusting, means for increasing, means for reducing, means for detecting, mean for maintaining, and/or means for scheduling may comprise one or more transmitters/receivers (e.g., TX/RX 618 and/or RX/TX 654) and/or one or more processors (e.g., TX Processor 616/668, RX Processor 670/656, and/or Controller/Processor 675/659).

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or combinations thereof.

Those of skill would further appreciate that the various illustrative logical blocks, modules, circuits, and algorithm steps described in connection with the disclosure herein may be implemented as electronic hardware, software/firmware, or combinations thereof. To clearly illustrate this interchangeability of hardware and software, various illustrative components, blocks, modules, circuits, and steps have been described above generally in terms of their functionality. Whether such functionality is implemented as hardware or software/firmware depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software/firmware module executed by a processor, or in a combination thereof. A software/firmware module may reside in RAM memory, flash memory, PCM (phase change memory), ROM memory, EPROM memory, EEPROM memory, registers, hard disk, a removable disk, a CD ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software/firmware, or combinations thereof. If implemented in software, the functions may be stored on or transmitted over as one or more instructions or code on a computer-readable medium. Computer-readable media include both computer storage media and communication media including any medium that facilitates transfer of a computer program from one place to another. A storage medium may be any available medium that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

As used herein, a phrase referring to “at least one of” a list of items refers to any combination of those items, including single members. As an example, “at least one of a, b, or c” is intended to cover a, b, c, a-b, a-c, b-c, and a-b-c, and any combination of any number of a, b, or c.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for managing transmission power at a user equipment (UE), comprising:
transmitting a packet; and
adjusting a transmission power to be used in one or more retransmissions of the packet based, at least in part, on a retransmission count of the packet.

2. The method of claim 1, wherein the adjusting comprises:
increasing the transmission power to be used for a number of retransmissions of the packet.

3. The method of claim 2, wherein the number of retransmissions is based on at least one of:
a type of channel being transmitted, or
a type of data carried in the packet.

4. The method of claim 2, wherein the number of retransmissions is based on a latency specification for data carried in the packet.

5. The method of claim 1, wherein the transmission power is adjusted based on detection of a threshold number of failed transmissions of the packet.

6. The method of claim 5, wherein the threshold number is based on a type of channel being transmitted.

7. The method of claim 5, wherein the threshold number is based on a type of data carried in the packet.

8. A method for managing transmission power at a user equipment (UE), comprising:
determining a specific absorption ratio (SAR) margin over a time period based on transmission power used for one or more previous transmissions during the time period;
adjusting transmission power to be used in transmitting one or more packets on an uplink channel based, at least in part, on the determined SAR margin; and
transmitting the one or more packets based on the adjusted transmission power.

9. The method of claim 8, wherein the adjusting is further based on a priority of data carried in the one or more packets.

10. The method of claim 9, wherein adjusting transmission power based on a priority of data carried in the one or more packets comprises:
reducing transmission power used for transmitting data having a low priority, and
increasing transmission power used for transmitting data having a high priority.

11. The method of claim 8, wherein the adjusting transmission power comprises:
upon detecting that no SAR margin exists for the time period, pausing data transmission.

12. The method of claim 8, wherein the adjusting transmission power comprises adjusting transmission power such that the UE exceeds an instantaneous SAR limit while maintaining compliance with an SAR limit over the time period.

13. An apparatus, comprising:
a transmitter configured to transmit a packet;
at least one processor configured to adjust a transmission power to be used in one or more retransmissions of the packet based, at least in part, on a retransmission count of the packet; and
a memory coupled to the at least one processor.

14. The apparatus of claim 13, wherein the at least one processor is configured to adjust the transmission power by increasing the transmission power to be used for a number of retransmissions of the packet.

15. The apparatus of claim 14, wherein the number of retransmissions is based on a type of channel being transmitted.

16. The apparatus of claim 14, wherein the number of retransmissions is based on a type of data carried in the packet.

17. The apparatus of claim 14, wherein the number of retransmissions is based on a latency specification for data carried in the packet.

18. The apparatus of claim 13, wherein the at least one processor is configured to adjust the transmission power based on detection of a threshold number of failed transmissions of the packet.

19. The apparatus of claim 18, wherein the threshold number is based on a type of channel being transmitted.

20. The apparatus of claim 18, wherein the threshold number is based on a type of data carried in the packet.
